(19) United States
(12) Patent Application Publication
(10) Pub. No.: US 2012/0012718 A1
(43) Pub. Date: Jan. 19, 2012

(54) ARTICULATED WINE AERATOR

(76) Inventor: Allan TISO, Fallbrook, CA (US)

(21) Appl. No.: 13/245,534

(22) Filed: Sep. 26, 2011

Related U.S. Application Data
(63) Continuation-in-part of application No. 29/341,930, filed on Aug. 14, 2009, now Pat. No. D624355.
(60) Provisional application No. 61/387,412, filed on Sep. 28, 2010.

(51) Int. Cl. F16M 13/02; A44B 18/00

(52) U.S. Cl. 248/205.2; 248/222.52; 248/222.11

(57) ABSTRACT

A bracket for a wine aerator, the bracket being removable connectible to a wine bottle and the aerator swings into position to receive wine from the bottle when the bottle is tilted to a pouring position. The wine is aerated as it passes through the aerator and into a receptacle.

### CROSS REFERENCE TO RELATED APPLICATION

This application is a continuation in part of application Ser. No. 29/341,930, filed 14 Aug. 2009, now patent Des. 624,355, issued 28 Sep. 2010, and claims priority from provisional application Ser. No. 61/387,412, filed 28 Sep. 2010, which applications are hereby incorporated herein by reference.

### FIELD OF THE INVENTION

The invention embodiments relate to a bracket for removably securing a wine aerator to a wine bottle which enables the aerator to swivel into position as the bottle is tipped.

### BACKGROUND

There are several types of wine aerators which enjoy various levels of popularity and commercial success. It is believed that most of them remain separate from the bottle from which wine is poured. One type of aerator is directly connected to the wine bottle, fitting much like a cork in the top of the bottle.

Typically, the aerator is held in one hand while the bottle is held in the other hand. The bottle is then tilted so that the wine pours into the aerator and then into the wine glass. In some cases the aerator may be structured to sit on top of the wine glass so that it need not be held while the wine is being poured from the bottle. Another alternative is a separate stand on which an aerator is placed in position over a wine glass.

### SUMMARY OF EMBODIMENTS OF THE INVENTION

The wine aerator according to embodiments of the invention is constructed with laterally extending pivoting projections which are pivotally mounted to a bracket. The bracket is removably secured to the neck of the wine bottle. Due to the position of the pivoting projections above the center of gravity, the aerator remains substantially upright at all times due to the function of gravity.

An optional embodiment includes a drip catcher which is positioned on the bracket and below the spout of the aerator when the wine bottle is returned to the upright position.

### BRIEF DESCRIPTION OF THE DRAWING

The objects, advantages, and features of the embodiments of the invention will be more clearly perceived from the following detailed description, when read in conjunction with the accompanying drawing, in which:

FIG. 1 is a perspective view of the wine aerator according to the invention;

FIG. 2 is an elevation view of the front thereof;

FIG. 3 is a right side view thereof, the opposite side being a mirror image of the side shown;

FIG. 4 is an elevation view of the back thereof;

FIG. 5 is a top view thereof;

FIG. 6 is a bottom view thereof;

FIG. 7 is a sectional view taken along cutting plane 7-7 in FIG. 3

FIG. 8 shows the aerator secured by means of a bracket to a bottle in upright position in accordance with an embodiment of the invention;

FIG. 9 shows the apparatus of FIG. 8 with the bottle partially tilted toward a pouring position; and

FIG. 10 shows the apparatus of FIG. 8 with the bottle in a pouring position and wine flowing into a wine glass.

### DETAILED DESCRIPTION OF EMBODIMENTS OF THE INVENTION

By way of a brief, general description, the aerator in accordance with embodiments of the invention is an inverted bell-shaped, generally cylindrical element. The aerator is pivotably secured to the bracket and stays upright by gravity. The bracket is removably secured to the wine bottle neck, so that, when the bottle is tilted to pour out wine, the wine flows into and through the aerator. The funnel shaped bowl is configured to receive wine from a bottle. The lower end constitutes a spout through which the wine exits the aerator into a wine glass. Side extensions are provided through which air is drawn as the wine passes down through the spout from the bowl.

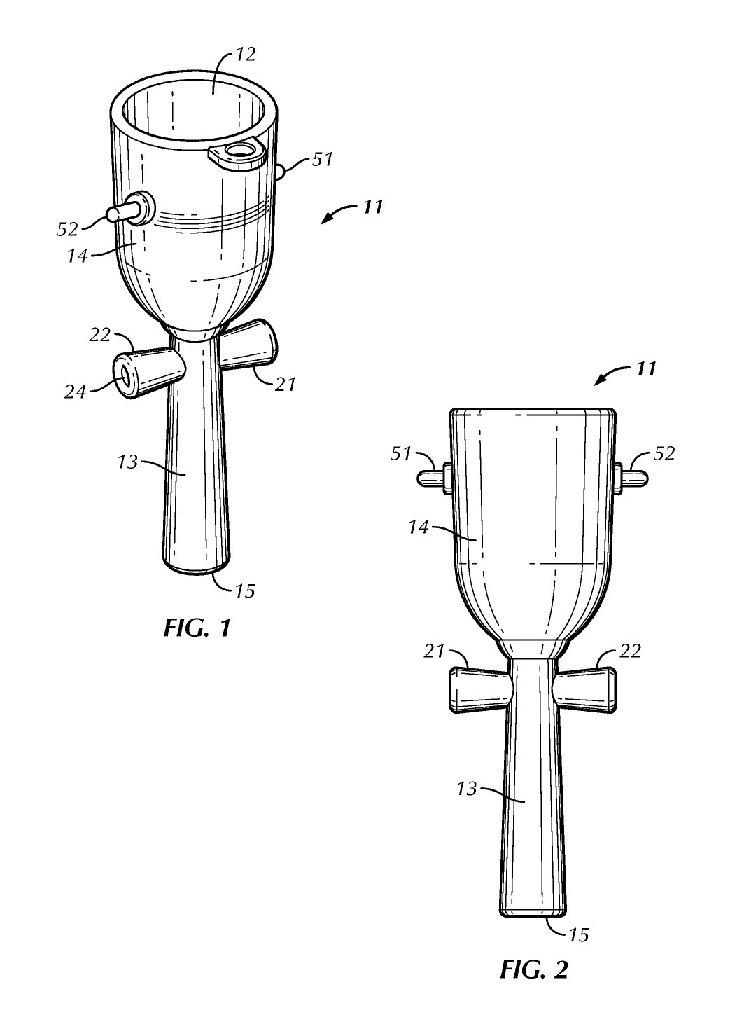

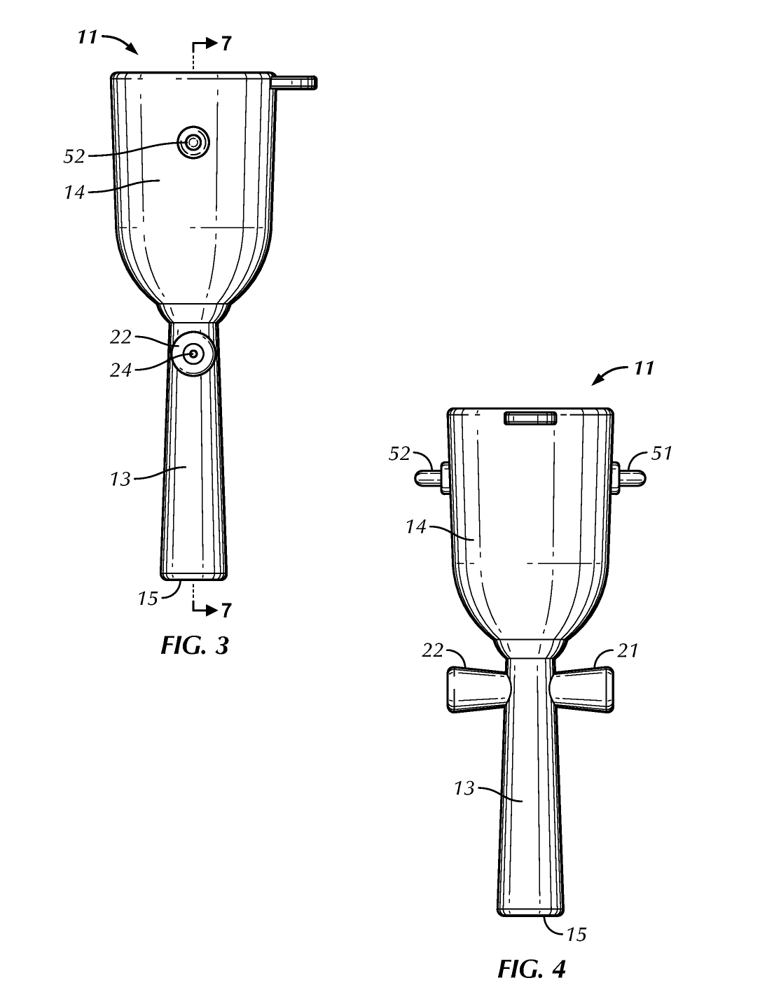

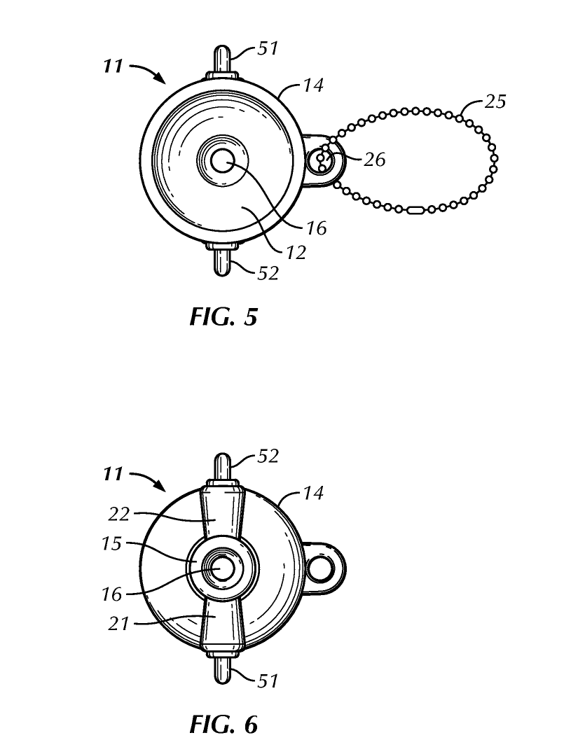

With reference now to the drawing, and more particularly to FIGS. 1-7, aerator 11 is formed with funnel-shaped top opening 12 of bowl 14, hollow stem 13 extending downwardly from the bowl and ending in spout 15 having a much smaller opening 16. Side protrusions 21 and 22 are formed with small air flow holes 23 and 24, respectively, which communicate from external of the aerator to tapered passageway 17 through stem 13. As shown in FIG. 5, chain 25 is optionally looped through optional tab 26. Typically chain 25 is of the detachable type.

The aerator functions in a relatively straightforward manner. Wine is poured into bowl 14, passes down through stem 13, drawing in air through holes 23 and 24 as it passes protrusions 21 and 22, and out opening 16 at the bottom of spout 15, into a receptacle, such as a wine glass.

With reference now to FIGS. 8-10, bracket 31 is formed with facing L-shaped side panels 32, 33 which are secured together at approximately their mid points by panel 34. Panel 34 is optionally formed with flange 35 on which is drip catcher 36 which is optionally attached. The function of flange 35 and drip catcher 36 will be explained below.

Side panel 32 has laterally extending portion 41 and linearly extending portion 42. These relative orientations are in relation to axis 37 of bottle 38 to which bracket 31 is adapted to be attached. Similarly, side panel 33 has laterally extending portion 43 and a corresponding linearly extending portion which is not visible in the drawing.

Side panels 32, 33 are made from a relatively rigid but somewhat deformable material such as a hard plastic. A preferred substance is a polycarbonate, but ABS, an acrylic, or any high impact polystyrene (HIPS) would be acceptable choices. Other materials, including metals or composites, could also be used. The side panels are formed with respective holes 45, adjacent their distal ends. Pins 51 and 52 on opposite sides of aerator bowl 14 are sized to fit into holes 45 to permit the aerator to freely pivot when mounted to bracket 31. The entire bracket 31 may be integrally formed, that is, side panels 32, 33 and connecting panel 34, as well as flange 35 can be a single molded plastic product. Even drip catcher 36 can be integrally formed with all the other portions of bracket 31. Alternatively, all the elements of the bracket can be separately formed and assembled into the bracket as is shown in the drawing. Pins 51 and 52 may be molded with aerator 11, or may be separately attached by any appropriate means to the sides of bowl 14. Pins 51 and 52 are preferably made of a similar hard plastic, but could be metal or any other rigid material.

The pins are positioned well above, or toward opening 12, with respect to the center of gravity of the aerator. Thus, from the operation of the force of gravity, aerator 11, when mounted to bracket 31, tends to be always vertically oriented. To mount the aerator to the bracket, deformable side panels are spread apart sufficiently to permit the aerator to be positioned between the side panels and the pins to be engaged in holes 45. Because of their stiffness, side panels 32 and 33 will return to their original positions and retain the aerator pivotally mounted to the bracket.

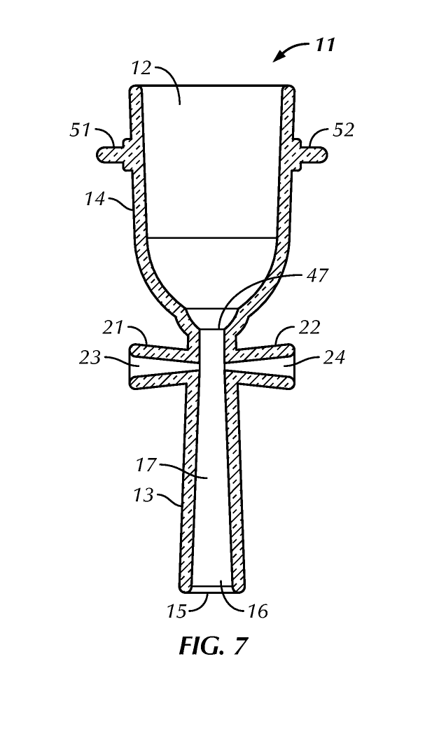

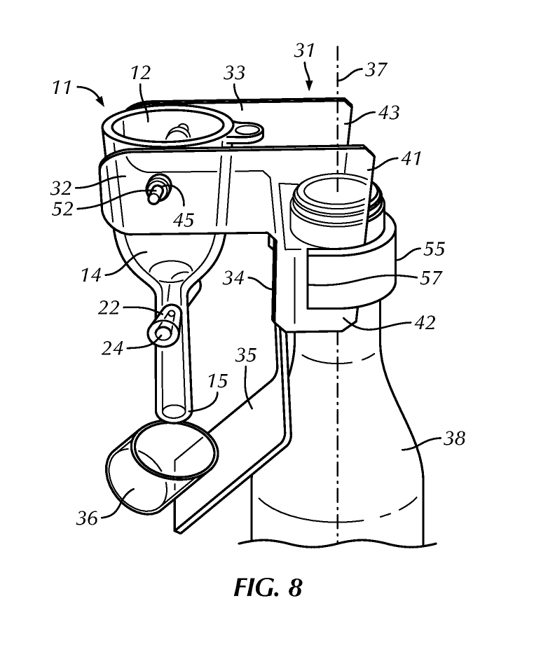

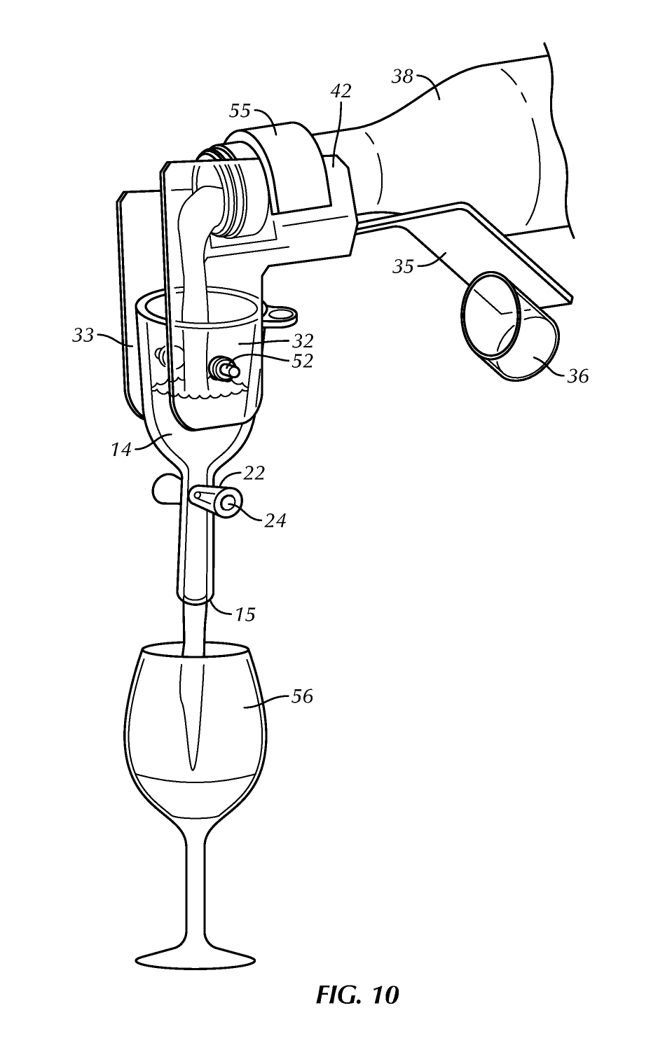

From FIG. 10 and the cross sectional view of FIG. 7, it is clear that bowl 14 receives liquid, such as wine, from a container, such as a bottle. The vertical fluid flow speeds up at neck 47 and pulls in air through openings 23, 24 in side protrusions 21, 22. As passageway 17 expands in the downward direction so that opening 16 in spout 15 is larger in diameter than is neck 47, the flow rate diminishes, thereby treating the liquid gently as it flows into a receptacle, such as a decanter or a wine glass 56.

Bracket 31 includes device 55 for removably mounting the bracket to the neck of a bottle, as shown in FIGS. 8-10, A hook-and-loop strap, an elastic band, or even a pliable but somewhat rigid strap with a clamp, where the length is adjustable (along the lines of a belt with holes in it), could be used and would be adjustable to different size bottle necks. Such strap can be passed through slots 57 in portions 42, 43 or each end of the strap can be secured to respective portions 42, 43.

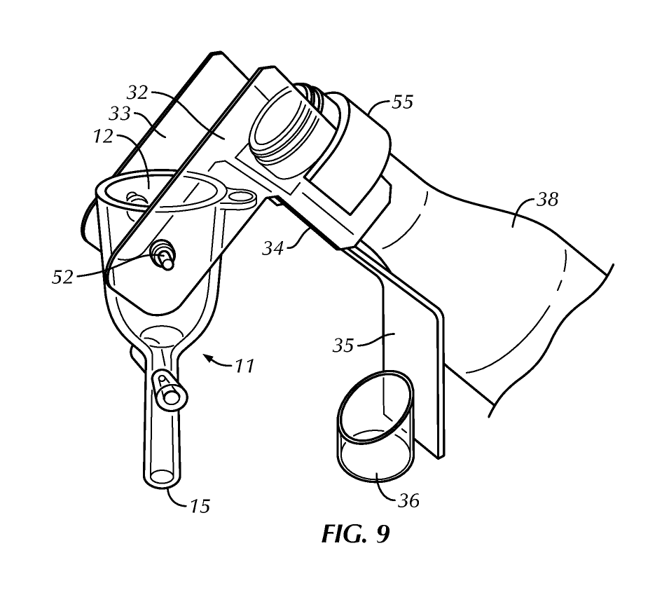

In operation, and using wine and a wine bottle for purposes of illustration, bracket 31 with aerator 11 pivotally attached is removably mounted to the neck of the bottle, adjacent to the bottle opening or top, as shown in FIG. 8. With reference to FIG. 9, as the bottle is tipped toward a pouring position, aerator 11 remains vertically oriented. From FIG. 10 it can be seen that as wine flows out of the bottle, it enters bowl 14 of the aerator and is aerated as it passes holes 23, 24 in side protrusions 21, 22. The thus aerated wine then flows out of spout 15 into wine glass (receptacle) 56.

When the bottle is tilted back to the vertical (non-pouring) position (see FIG. 8), flange 35, which is optionally connected to bracket 31 and is generally parallel with the wine bottle axis, positions drip catcher 36 directly beneath spout 15 of the aerator to catch any wine drops that may not have passed all the way through the aerator and into the wine glass.

While the invention embodiments have been exemplified by a wine glass, a wine bottle, and wine, it can be employed with any liquid container with the liquid passing through an aerator.

What is claimed is:

1. A bracket for an elongated wine aerator having a funnel-shaped opening of a first size at one end and a spout opening of a second, smaller size, at an opposite end, the aerator also having side protrusions with openings of a third size, smaller than the second size, the bracket comprising:
side panels secured together in spaced, facing relationship, said side panels having proximal and distal ends and extending outwardly from their proximal ends to form opposed distal ends, said side panels having opposite openings therein adjacent their distal ends;
side pins on opposite sides of the aerator, said side pins of the aerator being pivotally mounted in said opposite openings in said side panels; and
means on the bracket configured to removably secure the bracket to a bottle neck;
whereby when mounted to a bottle having an axis, the aerator is generally parallel to the axis of the bottle when the bottle is in a upright position, and when the bottle is tilted to pour liquid therefrom, the aerator pivots about said side pins under the influence of gravity to a position whereby the liquid in the bottle flows from the bottle into the funnel-shaped opening and out through the spout opening while mixing with air brought in through the openings in the side protrusions.

2. The bracket of claim 1, wherein said side panels are formed of relatively rigid and slightly deformable plastic.

3. The bracket of claim 2, wherein said side pins are mounted to the aerator.

4. The bracket of claim 2, wherein said side pins are integrally formed with the aerator.

5. The bracket of claim 1, wherein said removably securing means comprises a hook and loop strap.

6. The bracket of claim 1, wherein said removably securing means is an elastic strap.
